(19) United States
(12) Patent Application Publication
(10) Pub. No.: US 2026/0011789 A1
(43) Pub. Date: Jan. 8, 2026

(54) METHOD AND SYSTEM FOR MANUFACTURING ALL-SOLID-STATE BATTERY

(71) Applicants: HYUNDAI MOTOR COMPANY, Seoul (KR); KIA CORPORATION, Seoul (KR)

(72) Inventors: Young Jin NAM, Gyeonggi-do (KR); Sang Soo LEE, Gyeonggi-do (KR); Yeo Min YOON, Gyeonggi-do (KR); Yong Seok CHOI, Gyeonggi-do (KR); Min Sun KIM, Gyeonggi-do (KR)

(73) Assignees: HYUNDAI MOTOR COMPANY, Seoul (KR); KIA CORPORATION, Seoul (KR)

(21) Appl. No.: 19/258,631

(22) Filed: Jul. 2, 2025

(30) Foreign Application Priority Data
Jul. 5, 2024 (KR) 10-2024-0089032
Jun. 13, 2025 (KR) 10-2025-0078209

(51) Int. Cl. H01M 10/058; F26B 5/04; F26B 5/14

(52) U.S. Cl. CPC H01M 10/058; F26B 5/04; F26B 5/14

(57) ABSTRACT

A method and a system for manufacturing an all-solid-state battery may be capable of controlling change in performance, as the all-solid-state battery is exposed to moisture and oxygen.

### CROSS-REFERENCE TO RELATED APPLICATION

The present application claims the benefit of priority to Korean Patent Application Nos. 10-2024-0089032 and 10-2025-0078209, filed in the Korean Intellectual Property Office on Jul. 5, 2024 and Jun. 13, 2025, respectively, the entire contents of which are incorporated herein by reference.

### TECHNICAL FIELD

The present disclosure relates to relates to a method and a system for manufacturing an all-solid-state battery, capable of controlling the change in performance, as the all-solid-state battery is exposed to moisture and oxygen.

### BACKGROUND

Studies and researches have been conducted on various batteries to overcome the limitation of a lithium secondary battery in the capacity of a battery, the stability of the battery, the power of the battery, the increase in the size of the battery, or the decrease in the size of the battery. Among them, an all-solid-state battery refers to a battery having a solid electrolyte instead of a liquid electrolyte having been employed in conventional lithium secondary batteries. According to the all-solid-state battery, as a flammable solvent is not used inside the battery, the risk of firing or explosion, which has occurred due to the decomposition reaction of the conventional electrolyte, is removed, so stability is significantly improved. In addition, a solid electrolyte may maintain a path for moving lithium ions more stably, improving the energy density and the charging/discharging rate.

However, a sulfide-based solid electrolyte is significantly sensitive to external moisture and oxygen. Accordingly, studies and researches have been seamlessly carried out on a novel technology, which is more efficiently and economically, to solve issues related to the exposure to moisture and oxygen of the all-solid-state battery.

### SUMMARY

The present disclosure has been made to solve the above-mentioned problems occurring in the related art while advantages achieved by the related art are maintained intact.

An aspect of the present disclosure provides a method and a system for manufacturing an all-solid-state battery, configured for optimizing a moisture content of a solid electrolyte and an electrode of an all-solid-state battery manufactured by including a vacuum-drying step, improving an electrochemical property.

The technical problems to be solved by the present disclosure are not limited to the aforementioned problems, and any other technical problems not mentioned herein will be clearly understood from the following description by those skilled in the art to which the present disclosure pertains.

To solve the problem, the present disclosure provides a method and a system for manufacturing an all-solid-state battery.

More specifically, (1) the present disclosure provides a method for manufacturing an all-solid-state battery, which includes preparing a unit-cell stack including at least one cathode, at least one solid electrolyte layer, and at least one anode, vacuum-drying the unit-cell stack, and pressing the vacuum-dried unit-cell stack.
(2) The present disclosure provides a method for manufacturing an all-solid-state battery in which the vacuum-drying includes vacuum-drying the unit-cell stack at a temperature ranging from 50° C. to 200° C., in (1).
(3) The present disclosure provides a method for manufacturing an all-solid-state battery in which the vacuum-drying includes vacuum-drying the unit-cell stack for a time ranging from 30 minutes to 48 hours, in any one of (1) or (2).
(4) The present disclosure provides a method for manufacturing an all-solid-state battery in which a moisture change rate calculated through following Equation 1 ranges from 15% to 80%,

$$Equation 1$$

$$Moisture change rate ( \% ) = \frac{\begin{matrix}\begin{matrix}Moisture content ( ppm ) \\ in unit cell stack before vaccum drying -\end{matrix} \\ \begin{matrix}Moisture content ( ppm ) \\ in unit cell stack before vaccum drying\end{matrix}\end{matrix} \times 100 \%}{Moisture content ( ppm ) in unit cell stack before vaccum drying}$$

in any one of (1) to (3).
(5) The present disclosure provides a method for manufacturing an all-solid-state battery in which the pressing includes pressing the vacuum-dried unit-cell stack through a Warm Isostatic Pressing (WIP) manner or a roll-press manner, in any one of (1) to (4).
(6) The present disclosure provides a method for manufacturing an all-solid-state battery, which further includes forming a cell stack by stacking a plurality of unit-cell stacks pressed, receiving the cell stack in an exterior material, secondarily vacuum-drying the cell stack received in the exterior material, and sealing the exterior material, in any one of (1) to (5).
(7) The present disclosure provides a method for manufacturing an all-solid-state battery in which the secondarily vacuum-drying includes vacuum-drying the cell stack received in the exterior material at a temperature ranging from 50° C. to 200° C., in any one of (1) to (6).
(8) The present disclosure provides a method for manufacturing an all-solid-state battery in which the secondarily vacuum-drying includes vacuum-drying the cell stack received in the exterior material for a time ranging from 30 minutes to 48 hours, in any one of (1) to (7).
(9) The present disclosure provides a method for manufacturing an all-solid-state battery in which the forming of the cell stack includes stacking the plurality of unit-cell stacks pressed and performing a tab-welding process for the plurality of unit-cell stacks stacked, in any one of (1) to (8).
(10) The present disclosure provides a method for manufacturing an all-solid-state battery, which further includes receiving the unit-cell stack in an exterior material before vacuum-drying the unit-cell stack, and sealing the exterior material after the vacuum-drying of the unit-cell stack and before the pressing of the unit-cell stack, any one of (1) to (9).
(11) The present disclosure provides a system for manufacturing an all-solid-state battery, which includes a unit-cell stacking device configured to stack at least one cathode, at least one a solid electrolyte layer, and at least one anode to form a unit-cell stack, a vacuum-drying device configured to vacuum-dry the unit-cell stack, and a pressing device configured to press the vacuum-dried unit-cell stack.
(12) The present disclosure provides a method for manufacturing an all-solid-state battery, which further includes a cell stack device configured to form a cell stack by stacking a plurality of unit-cell stacks pressed, a stacking packaging device configured to receive the cell stack in an exterior material, a secondarily vacuum-drying device configured to secondarily vacuum-dry the cell stack received in the exterior material, and a stack sealing device configured to seal the exterior material, in (11).
(13) The present disclosure provides a method for manufacturing an all-solid-state battery, which further includes a cell packaging device configured to receive the unit-cell stack in a cell exterior material, and a cell sealing device configured to seal the cell exterior material, the cell packaging device is interposed between the unit-cell stacking device and the vacuum-drying device, and the cell sealing device is disposed to a rear stage of the vacuum-drying device, in any one of (11) or (12).

### BRIEF DESCRIPTION OF THE DRAWINGS

The above and other objects, features and advantages of the present disclosure will be more apparent from the following detailed description taken in conjunction with the accompanying drawings:

FIG. 1 is a graph illustrating the change in cycle characteristic of all-solid-state batteries manufactured according to Embodiments 1-1, 1-2 and 1-3, and Comparative example 1 of the present disclosure;

FIG. 2A is a graph illustrating the change in cycle characteristic of all-solid-state batteries manufactured according to Embodiments 1-2, 2-1, and 2-2, and Comparative example 1 of the present disclosure;

FIG. 2B is a graph illustrating the change in cycle characteristic of all-solid-state batteries manufactured according to Embodiments 1-1 and 3-1, and Comparative example 1 of the present disclosure;

FIG. 3 is a graph illustrating a voltage change as a function of capacities of an all-solid-state battery manufactured according to Embodiment 4-1, and Comparative examples 2 and 3 of the present disclosure;

FIG. 4 is a diagram illustrating a manufacturing system of an all-solid-state battery according to the present disclosure including a unit-cell stacking device, a vacuum-drying device, and a pressing device;

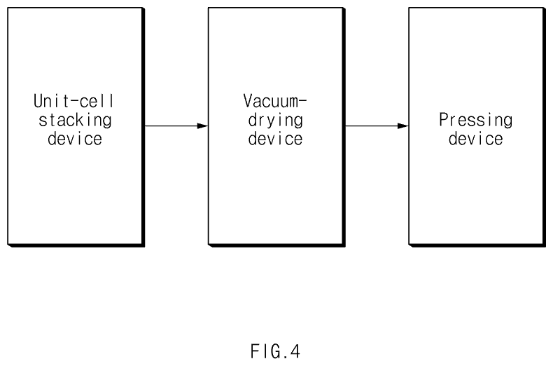

FIG. 5 is a diagram illustrating a manufacturing system of an all-solid-state battery according to the present disclosure including a unit-cell stacking device, a vacuum-drying device, a pressing device, a cell stack device, a stack packaging device, a secondarily vacuum-drying device, and a stack sealing device; and

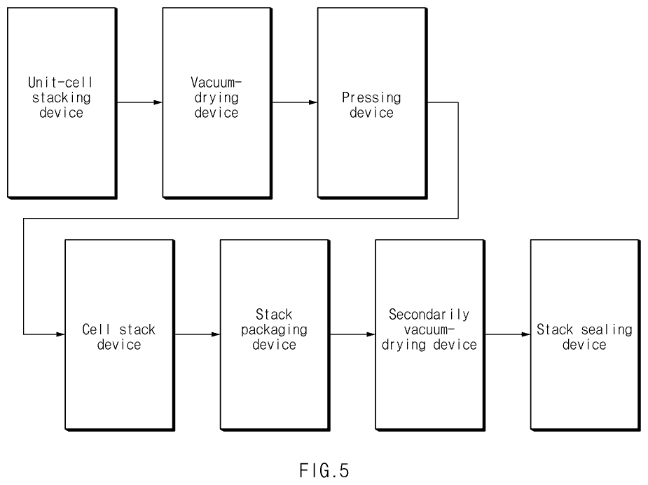

FIG. 6 is a diagram illustrating a manufacturing system of an all-solid-state battery according to the present disclosure including a unit-cell stacking device, a cell packaging device, a vacuum-drying device, a cell sealing device, and a pressing device.

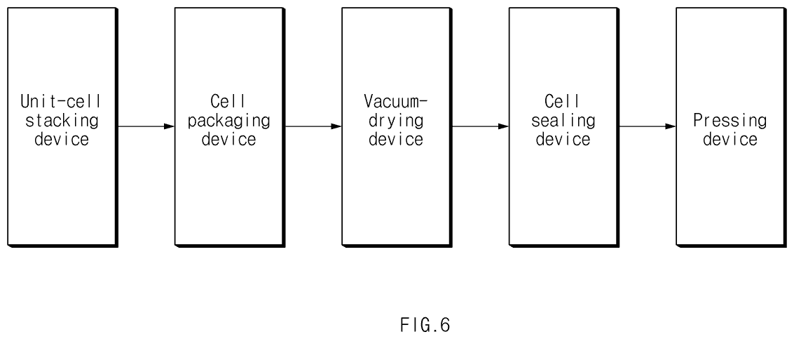

### DETAILED DESCRIPTION

Hereinafter, embodiments disclosed in the present disclosure will be described in more detail.

Terms or words used in the present specification and the claims should not be interpreted as commonly-used dictionary meanings, but be interpreted as to be relevant to the technical scope of the present disclosure based on the fact that the inventor may properly define the concept of the terms to explain the invention in best ways.

Method for Manufacturing all-Solid-State Battery

An embodiment of the present disclosure provides a method (hereinafter, a manufacturing method) for manufacturing an all-solid-state battery, which includes the steps for preparing a unit-cell stack including at least one cathode, at least one solid electrolyte layer, and at least one anode, for vacuum-drying the unit-cell stack, and for pressing the vacuum-dried unit-cell stack.

Hereinafter, the manufacturing method will be described step by step.

### Preparing Unit-Cell Stack

This step may be the step for preparing a unit-cell stack including at least one cathode, at least one solid electrolyte layer, and at least one anode.

The cathode may have a form in which a cathode active material layer is coated on a current collector, and may include the cathode active material, a binder, and a conductive material.

For example, the current collector may include copper, stainless steel, aluminum, nickel, titanium, sintered carbon, a material obtained by performing surface-treatment for copper or stainless steel, or the surface of copper or stainless steel with carbon, nickel, titanium, or silver, and/or an aluminum-cadmium alloy.

The cathode active material may be an oxide active material or a sulfide active material.

The oxide active material may include a rock salt type active material, such as LiCoO₂, LiMnO₂, LiNiO₂, LiVO₂, Li₁₊ₓNi_{1/3}Co_{1/3}Mn_{1/3}O₂, a spinel type active material, such as LiMn₂O₄, Li(Ni_{0.5}Mn_{1.5})O₄, reverse spinel type active material, such as LiNiVO₄, or LiCoVO₄, an olivine-type active material, such as LiFePO₄, LiMnPO₄, LiCoPO₄, or LiNiPO₄, a silicon-containing active material, such as Li₂FeSiO₄, Li₂MnSiO₄, a rock salt type active material, such as LiNi_{0.8}Co_{(0.2-x)}AlₓO₂(0<x<0.2), which is obtained by substituting a portion of transition metal with a heterogeneous metal, a spinel-type active material, such as Li₁₊ₓMn_{2-x-y}M_{y}O₄ (M is at least one of Al, Mg, Co, Fe, Ni, and Zn; 0<x+y<2), which is obtained by substituting a portion of the transition metal with a heterogeneous metal, or lithium titanate such as Li₄TisO₁₂. The sulfide active material may be copper Chevreul, iron sulfide, cobalt sulfide, or nickel sulfide.

The binder, which fixes materials of the cathode active material layer, may include at least one type selected from the group consisting of polytetrafluoroethylene, polyethylene oxide, polyethyleneglycol, polyacrylonitrile, polyvinylchloride, polymethylmethacrylate, polypropyleneoxide, polyphosphazene, polysiloxane, polydimethylsiloxane, polyvinylidenefluoride, polyvinylidene fluoride-hexafluoropropylene copolymer (PVDF-HFP), polyvinylidene fluoride-chlorotrifluoroethylene copolymer (PVDF-CTFE), polyvinylidene fluoride-tetrafluoroethylene copolymer (PVDF-TFE), polyvinylidenecarbonate, polyvinylpyrrolidinone, styrene-butadiene rubber, nitrile-butadiene rubber, and hydrogenated nitrile butadiene rubber.

The conductive material may improve the electrical conductivity of the cathode active material layer, and may include at least one type selected from the group consisting of carbon-based material, such as natural graphite, artificial graphite, carbon black, acetylene black, ketjen black, carbon fiber, and a carbon nano-tube; a metal-based material in the form of metal powders or metal fibers containing copper, nickel, aluminum, or silver; and a conductive polymer such as polyphenylene derivatives.

The solid electrolyte layer may include the solid electrolyte and the binder, and the solid electrolyte may be an inorganic solid electrolyte, such as a sulfide-based solid electrolyte, an oxide-based solid electrolyte, or a halide-based solid electrolyte, or a solid polymer electrolyte.

The solid electrolyte may be preferably a sulfide-based solid electrolyte, and moisture may be effectively controlled through the vacuum-drying step thereafter, when the solid electrolyte includes the sulfide-based solid electrolyte. The sulfide-based solid electrolyte may be various general sulfide-based solid electrolyte without being specifically limited. Preferably, the sulfide-based solid electrolyte may include at least one selected from the group consisting of Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which ‘, m’ and ‘n’ is positive numbers; Z is one of Ge, Zn, and Ga), Li₂S—GeS₂, Li₂S—SiS₂—Li₃PO₄, Li₂S—SiS₂-LiₓMO_{y} (in which x and y are positive numbers; M is one among P, Si, Ge, B, Al, Ga, and In), and Li₁₀GeP₂S₁₂.

The anode may have a form in which an anode active material layer is coated on a current collector, and the anode active material may include the anode active material, a binder, and a conductive material.

The current collector, the binder, and the conductive material may be applied identically to the binder and the conductive material which may be included in the cathode.

The anode active material may include at least one selected from the group consisting of lithium metal, graphite, silicon, silicon oxide (SiOx), silicon carbide (Si-Cx), a lithium titanium oxide (LTO), graphite, and carbon-nano tube (CNT).

The unit-cell stack prepared according to an embodiment of the present disclosure may have a form in which the anode, the solid electrolyte layer, and the cathode are sequentially stacked. In the instant case, at least one anode, at least one solid electrolyte layer, and at least one cathode may be included in the unit-cell stack. Preferably, the unit-cell stack according to an embodiment disclosed in the present disclosure may include at least one cathode, at least two cathodes, at least three cathodes, at least four cathodes, or at least five cathodes, and at most twenty cathodes, at most nineteen cathodes, at most eighteen cathodes, at most seventeen cathodes, at most sixteen cathodes, or at most fifteen cathodes. The unit-cell stack may include at least two anodes and at least two solid electrolyte layers, at least three anodes and at least three solid electrolyte layers, at least four anodes and at least four solid electrolyte layers, at least five anodes and at least five solid electrolyte layers, or at least six anodes and at least six solid electrolyte layers, and at most twenty-one anodes and at most twenty-one solid electrolyte layers, at most twenty anodes and at most twenty solid electrolyte layers, at most nineteen anodes and at most nineteen solid electrolyte layers, at most eighteen anodes and at most eighteen solid electrolyte layers, at most seventeen anodes and at most seventeen solid electrolyte layers, or at most sixteen anodes and at most sixteen solid electrolyte layers.

### Vacuum-Drying Step

This step may be the step for vacuum-drying the unit-cell stack to adjust a moisture content in the unit-cell stack.

The vacuum-drying step may be performed under a vacuum environment. Specifically, the vacuum-drying step may be performed in a vacuum-chamber, or an inert-gas atmosphere.

The pressure for the vacuum-drying may be at least 0.001 mbar, at least 0.01 mbar, at least 0.02 mbar, at least 0.03 mbar, at least 0.04 mbar, at least 0.05 mbar, at least 0.06 mbar, at least 0.07 mbar, at least 0.08 mbar, at least 0.09 mbar, or at least 0.10 mbar, and at most 1,000 mbar, at most 900 mbar, at most 800 mbar, at most 700 mbar, at most 600 mbar, at most 500 mbar, at most 400 mbar, at most 300 mbar, at most 200 mbar, at most 100 mbar, at most 50 mbar, at most 40 mbar, at most 30 mbar, or at most 20 mbar. Within the above range, moisture may be easily controlled.

The vacuum-drying may be performed at a temperature of at least 50° C., at least 60° C., at least 70° C., at least 80° C., or at least 90° C., and at most 200° C., at most 190° C., at most 180° C., at most 170° C., or at most 160° C. When the temperature is maintained within the above range, only moisture may be efficiently controlled without degrading performance of the all-solid-state battery, improving capacity and lifespan characteristics of the all-solid-state battery.

The vacuum-drying may be performed for at least 30 minutes, at least 1 hour, at least 2 hours, at least 3 hours, or at least 5 hours, and at most 48 hours, at most 44 hours, at most 40 hours, at most 36 hours, at most 32 hours, at most 28 hours, at most 24 hours, at most 20 hours, at most 16 hours, or at most 12 hours. Within the above range, the moisture content may be appropriately adjusted and the capacity and lifespan characteristics of the all-solid-state battery manufactured later may be improved without degrading the performance of the all-solid-state battery.

The vacuum-drying step may be preferably included before the pressing step. Most preferably, the vacuum-drying step may be close to the pressing step or immediately before the pressing step. In the instant case, a moisture removal effect may be maximized. When the vacuum-drying step is performed after the pressing step, the moisture compressed to the electrode may not be removed. Accordingly, the moisture remaining in the all-solid-state battery makes reaction with the solid electrolyte or the lithium metal to generate hydrogen sulfide gas, degrading the mechanical stability inside the all-solid-state battery. Accordingly, the cycle performance of the all-solid-state battery may be degraded to shorten the lifespan of the all-solid-state battery.

The moisture change rate calculated through Equation 1 after the vacuum-drying step may be at least 15%, at least 17%, at least 19%, at least 21%, at least 23%, or at least 25%, and at most 80%, at most 78%, at most 76%, at most 74%, at most 72%, or at most 70%.

$$Equation 1$$

$$Moisture change rate ( \% ) = \frac{\begin{matrix}\begin{matrix}Moisture content ( ppm ) \\ in unit cell stack before vaccum drying -\end{matrix} \\ \begin{matrix}Moisture content ( ppm ) \\ in unit cell stack before vaccum drying\end{matrix}\end{matrix} \times 100 \%}{Moisture content ( ppm ) in unit cell stack before vaccum drying}$$

Within the above range, moisture may be effectively removed from the all-solid-state battery. Accordingly, the cycle performance of the all-solid-state battery manufactured may be improved, and a capacity characteristic and a resistance characteristic may be improved.

### Pressing Step

This step may be to maximize the contact interface between each electrode and a solid electrolyte by pressing the unit-cell stack after the vacuum-drying, reducing the interface resistance. Specifically, the pressing step according to an embodiment included in the present disclosure may be performed through a Warm Isostatic Pressing (WIP) manner or a Roll Press manner.

The pressing step may be performed under the pressure of at least 100 MPa, at least 150 MPa, at least 200 MPa, at least 250 MPa, at least 300 MPa, or at least 350 MPa, and at most 800 MPa, at most 750 MPa, at most 700 MPa, at most 650 MPa, at most 600 MPa, at most 550 MPa, at most 500 MPa, or at most 450 MPa.

The pressing step may be performed at a temperature of at least 50° C., at least 55° C., at least 60° C., at least 65° C., at least 70° C., or at least 75° C., and at most 110° C., at most 105° C., at most 100° C., at most 95° C., at most 90° C., or at most 85° C., when the pressing step is performed through WIP. Within the pressure range and the temperature range, the interface resistance between the electrode and the solid electrolyte may be minimized, improving the ion conductivity, and improving a lifespan characteristic and a resistance characteristic.

The manufacturing method according to an embodiment included in the present disclosure may further include the steps for forming a cell stack by stacking a plurality of unit-cell stacks pressed, for receiving the cell stack in an exterior material, for secondarily vacuum-drying the cell stack received in the exterior material, and for sealing the exterior material.

The step for forming the cell stack is the step for forming the cell stack by stacking the plurality of unit-cell stacks pressed. In the instant case, the unit-cell stack may be stacked in a number of at least 1, at least 2, at least 3, at least 4, at least 5, at least 6, at least 7, at least 8, at least 9, or at least 10, and at most 100, at most 90, at most 80, at most 70, at most 60, at most 50, at most 40, at most 30, or at most 20.

Thereafter, the cell stack may be welded through a laser or an ultrasound. Accordingly, the mechanical strength of the all-solid-state battery is enhanced, and the electrical contact is improved to reduce the resistance more.

The cell stack may be received in the exterior material thereafter, and the exterior material may include various materials without particular limitation, as long as the materials protect components inside the all-solid-state battery, and maintain the electrochemical stability.

The cell stack received in the exterior material may undergo the secondarily vacuum-drying step. The secondarily vacuum-drying step may be a step for additionally removing moisture present in the cell stack. For the all-solid-state battery after the secondarily vacuum-drying step, a large amount of remaining moisture is removed. Accordingly, the lifespan characteristic and the resistance characteristic of the all-solid-state battery may be improved.

The secondarily vacuum-drying step may be performed at a temperature of at least 50° C., at least 60° C., at least 70° C., at least 80° C., or at least 90° C., and at most 200° C., at most 190° C., at most 180° C., at most 170° C., or at most 160° C. When the temperature is maintained within the above range, only moisture may be efficiently controlled without degrading performance of the all-solid-state battery, improving the capacity characteristic and the lifespan characteristic of the all-solid-state battery.

The secondarily vacuum-drying step may be performed for at least 30 minutes, at least 1 hour, at least 2 hours, at least 3 hours, or at least 5 hours, and at most 48 hours, at most 44 hours, at most 40 hours, at most 36 hours, at most 32 hours, at most 28 hours, at most 24 hours, at most 20 hours, at most 16 hours, or at most 12 hours. Within the above range, the moisture content may be appropriately adjusted and the capacity characteristic and the lifespan characteristic of the all-solid-state battery manufactured thereafter may be improved without degrading the performance of the all-solid-state battery.

An embodiment included in the present disclosure may include the step for sealing the exterior material including the cell stack after the secondarily vacuum-drying step to manufacture the final all-solid-state battery. The sealing manner may not be limited, as long as the exterior material is welded to protect the cell stack from the external environment.

The method for manufacturing the all-solid-state battery according to an embodiment included in the present disclosure may further include the steps for receiving the unit-cell stack in the exterior material before the vacuum-drying the unit-cell stack, and sealing the exterior material after the vacuum-drying step and before the pressing step, when the manufacturing method does not include the step for forming the cell stack.

When the all-solid-state battery is manufactured, as the manufacturing method includes the steps for receiving the unit-cell stack in the exterior material before the vacuum-drying the unit-cell stack and for sealing the exterior material after the vacuum-drying step and the pressing step, the all-solid-state battery may not include the cell stack. In the instant case, the unit-cell stack received in the exterior material is sealed and then pressed such that the final all-solid-state battery is manufactured.

System for Manufacturing all-Solid-State Battery

An embodiment included in the present disclosure provides a manufacturing system to realize the manufacturing method described above. An embodiment included in the present disclosure provides a unit-cell stacking device to stack at least one cathode, at least one second solid electrolyte layer, and at least one anode to form the unit-cell stack, a vacuum-drying device to vacuum dry the unit-cell stack, and a pressing device to press the vacuum-dried unit-cell stack.

The unit-cell stacking device is to perform the step for preparing the unit-cell stack described above, the vacuum-drying device is to perform the vacuum-drying step, and the pressing device is to press the vacuum-dried unit-cell stack.

In addition, the system (or the manufacturing system) for manufacturing the all-solid-state battery according to an embodiment included in the present disclosure may additionally include a cell stack device to perform the step for forming the cell stack, a stack packaging device to perform the step for receiving the cell stack in the exterior material, a secondarily vacuum-drying device to perform the step for secondarily vacuum-drying the cell stack received in the exterior material, and a stack sealing device to perform the step for sealing the exterior material.

The system for manufacturing the all-solid-state battery according to an embodiment included in the present disclosure may further include the cell packaging device to perform the step for receiving the unit-cell stack in the exterior material before the vacuum-drying the unit-cell stack, and the cell sealing device to perform the step for sealing the exterior material before the pressing step, when the manufacturing method according to an embodiment included in the present disclosure does not include the step for forming the cell stack.

Hereinafter, embodiments and experimental examples for describing the present disclosure in detail will be described in more detail, but the present disclosure is not limited to the embodiments and the experimental examples. However, embodiments of the present disclosure may have various modifications, and the scope of the present disclosure is not limited to following embodiments. The embodiments of the present disclosure are disposed to describe the present disclosure for those skilled in the art more completely.

### Embodiment 1-1

Two cathodes, each of which included an Al current collector and NCM 711 (Li(Ni_{0.7}Co_{0.15}Mn_{0.15}) O₂), two solid electrolytes including Li₆PS₅Cl, and two anodes, each of which included a Ni current collector, and carbon, were stacked and a carbon-based binder and a butadiene rubber-based binder were used to prepare a unit-cell stack. Thereafter, the unit cell stack was vacuum-dried in a vacuum oven at 60° C. for 12 hours and pressed through a WIP manner under the conditions of 450 MPa and 80° C. Thereafter, the pressed stack structure was put into an Al pouch disposed as an exterior material, and sealed to prepare an all-solid-state battery.

### Embodiment 1-2

An all-solid-state battery was manufactured in the same manner as in Embodiment 1-1, except that the unit-cell stack was vacuum-dried at 100° C. for 12 hours, instead of 60° C., when compared to Embodiment 1-1.

### Embodiment 1-3

An all-solid-state battery was manufactured in the same manner as in Embodiment 1-1, except that the unit-cell stack was vacuum-dried at 150° C. for one hour, instead of the conditions of 60° C. and 12 hours, when compared to Embodiment 1-1.

### Embodiment 2-1

An all-solid-state battery was manufactured in the same manner as in Embodiment 1-1, except that the unit-cell stack was vacuum-dried at 100° C. for one hour, instead of the conditions of 60° C. and 12 hours, when compared to Embodiment 1-1.

### Embodiment 2-2

An all-solid-state battery was manufactured in the same manner as in Embodiment 1-1, except that the unit-cell stack was vacuum-dried at 100° C. for six hours, instead of the conditions of 60° C. and 12 hours, when compared to Embodiment 1-1.

### Embodiment 3-1

An all-solid-state battery was manufactured in the same manner as in Embodiment 1-1, except that the unit-cell stack was vacuum-dried at 60° C. for two hours, instead of the condition of 12 hours, when compared to Embodiment 1-1.

### Embodiment 4-1

An all-solid-state battery was manufactured in the same manner as in Embodiment 1-1, except that NCM 811 (Li(Ni_{0.8}Co_{0.1}Mn_{0.1}) O₂) was used as the cathode active material, instead of NCM 711, when compared to Embodiment 1-2.

### Comparative Example 1

An all-solid-state battery was manufactured in the same manner as in Embodiment 1-1, except that the vacuum-drying step was not performed, when compared to Embodiment 1-1.

### Comparative Example 2

An all-solid-state battery was manufactured in the same manner as in Embodiment 4-1, except that the vacuum-drying step was not performed, when compared to Embodiment 4-1.

### Comparative Example 3

An all-solid-state battery was manufactured in the same manner as in Embodiment 4-1, except that the vacuum-drying step was performed after the pressing step through ‘WIP’, when compared to Embodiment 4-1.

The vacuum-drying condition performed in the manufacturing method according to the embodiments and the comparatives examples and the cathode active material used in the manufacturing method were summarized as in following Table 1.

TABLE 1

| | | | | Cathode active |
|---|---|---|---|---|
| | Time | | Temperature | material |
| Embodiment | 12 | hours | 60° C. | NCM 711 |
| 1-1 | | | | |
| Embodiment | 12 | hours | 100° C. | NCM 711 |
| 1-2 | | | | |
| Embodiment | One | hour | 150° C. | NCM 711 |
| 1-3 | | | | |
| Embodiment | One | hour | 100° C. | NCM 711 |
| 2-1 | | | | |
| Embodiment | Six | hours | 100° C. | NCM 711 |
| 2-2 | | | | |
| Embodiment | One | hour | 60° C. | NCM 711 |
| 3-1 | | | | |
| Embodiment | 12 | hours | 100° C. | NCM 811 |
| 4-1 | | | | |

| | | | |
|---|---|---|---|
| Comparative | — | — | NCM 711 |
| example 1 | | | |
| Comparative | — | — | NCM 811 |
| example 2 | | | |

| | | | | |
|---|---|---|---|---|
| Comparative | 12 | hours | 100° C. | NCM 811 |
| example 3 | | | | |

### Embodiment 1 Observation of Moisture Content in all-Solid-State Battery Resulting from Vacuum-Drying

In the manufacturing processes according to Embodiment 1-1 and Embodiment 1-2, moisture content was measured in each layer before and after assembling the unit-cell stack, and after vacuum-drying, and summarized in Table 2.

Specifically, the moisture content was analyzed using Carl Fischer Titration. Specifically, 0.5 g of a test sample was sampled in an airtight container using Metrohm's calfisher moisture meter, and heated to 120° C., and produced moisture was allowed to flow into a reaction solution and quantitatively measured (flow gas: Ar). In the instant case, the moisture content was calculated in unit of ppm.

TABLE 2

| | | | After vacuum- | After vacuum- | |
|---|---|---|---|---|---|
| | Before | After | drying | drying | |
| | assembling | assembling | Embodiment | Embodiment | |
| | stack | stack | 1-1 | 1-2 | |
| Cathode | 1.626 ppm | 4.613 ppm | 3.312 ppm | 7.64 | ppm |
| Anode | 2.954 ppm | 7.296 ppm | 6.254 ppm | 2.319 | ppm |
| Solid | 2.744 ppm | 5.171 ppm | 4.235 ppm | 2.477 | ppm |
| electrolyte | | | | | |

It may be recognized through Table 2 that moisture content was rapidly increased in each layer after the stack was assembled. Accordingly, it may be recognized that the moisture content was increased, as each electrode was exposed to moisture in the assembling step of the unit-cell stack. In addition, it may be recognized that lower moisture content was exhibited after vacuum-drying, when compared to immediately after the assembly of the stack.

Accordingly, it may be recognized that the moisture content in each layer of the all-solid-state battery was effectively adjusted through the vacuum-drying step included in the manufacturing method of the present disclosure.

### Experimental Example 2: Observation of Electrochemical Properties in all-Solid-State Battery Resulting from Vacuum-Drying

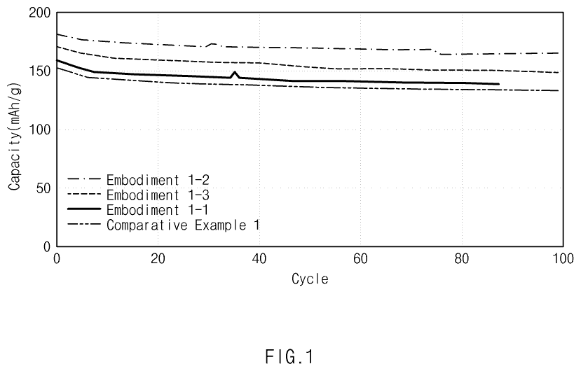

To determine the electrochemical properties of the all-solid-state batteries according to Embodiments 1-1, 1-2 and 1-3, and Comparative example 1, a cycle of maintaining the charging/discharging rate to 0.2 C, under the temperature of 30° C. and of performing charging/discharging operations within the voltage ranging from 2.0 V to 4.25 V was repeatedly performed 100 times, and the change in capacity resulting from 100 cycles was shown in the graph of FIG. 1. In addition, discharging capacity [mAh/g], Coulomb efficiency [%] and DC-IR [%] of the all-solid-state batteries manufactured according to Embodiments 1-1 and 1-2, and Comparative example 1 were measured through Following measuring manners, and the measurement result was summarized in following Table 3.

### [Measurement Manner]

Discharging capacity [mAh/g]: the charging/discharging was performed at 0.2 C in a voltage ranging from 2.0 V to 4.25 V, and a discharging terminal capacity was measured.

Coulombic efficiency (%): a discharging capacity was divided by a charging capacity, and the result was multiplied by 100, calculating the Coulombic efficiency.

DC-IR [%]: a voltage drop was measured immediately after a constant current was applied at a point of 50% of SOC value of the all-solid-state battery, and the measurement result was divided by the constant current, calculating DC-IR [%].

TABLE 3

| | Discharging | | |
|---|---|---|---|
| | capacity | Coulombic | |
| | [mAh/g] | efficiency (%) | DC-IR[Ω] |
| Embodiment 1-1 | 158.7 | 90.9 | 12.1 |
| Embodiment 1-2 | 177.9 | 92.8 | 10.7 |
| Comparative | 151.1 | 86.5 | 15.7 |
| example 1 | | | |

It may be recognized through FIG. 1 that Embodiments 1-1, 1-2 and 1-3 of the present disclosure applied with the vacuum-drying step showed higher initial capacity, when compared to the comparative example. In addition, when 100 cycles were repeated, the capacity was maintained to be higher, when compared to the comparative example. Accordingly, when the vacuum-drying step of the present disclosure was applied, a large amount of moisture was removed from the electrode. Accordingly, it may be recognized that the all-solid-state battery showed the higher initial capacity and the higher capacity retention rate.

In addition, it may be recognized through Table 3 that the all-solid-state battery according to Embodiments 1-1 and 1-2 of the present disclosure employing the vacuum-drying step exhibited higher discharging capacity, more excellent Coulombic efficiency, and lower DC-IR showing the internal resistance of the all-solid-state battery, when compared to the all-solid-state battery according to the comparative example. Accordingly, it may be recognized that the all-solid-state battery, which was controlled in moisture content through the vacuum-drying step of the present disclosure, satisfied higher efficiency, higher capacity, and higher stability.

### Experimental Example 3: Observation of Change in the Capacity of all-Solid-State Battery Depending on Time and Temperature of Vacuum-Drying

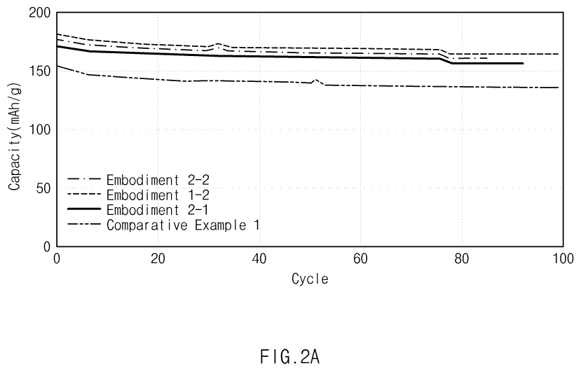

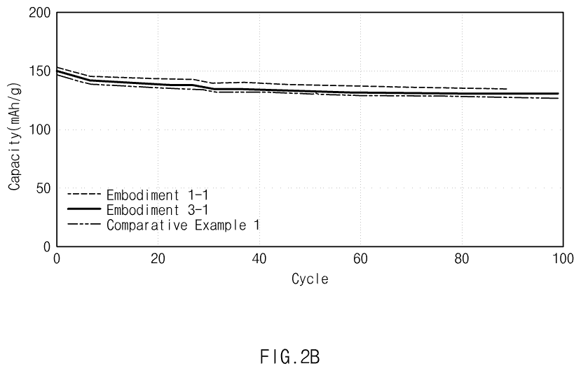

To observe the change in capacity depending on the number of cycles of the all-solid-state battery manufactured according to Embodiments 1-3, 2-1, and 2-2, and Comparative example 1, a cycle test was conducted for 100 cycles under the same conditions as in Experimental Example 2. The resulting capacity changes over 100 cycles were presented in a graph as shown in FIG. 2A. In addition, for Embodiment 1-1, 3-1, and Comparative example 1, the capacity change during repeated cycles was measured in the same manner and is shown in FIG. 2B.

It may be recognized through FIGS. 2A and 2B that the all-solid-state battery manufactured according to an embodiment of the present disclosure, which includes the vacuum-drying step, showed higher initial capacity, when compared to a Comparative example. In addition, it may be recognized that the higher capacity retention rate was maintained even though the cycle was repeated. In particular, it may be recognized that Embodiments 1-3, 2-1 and 2-2 in which vacuum-drying was performed at higher temperatures exhibited higher initial capacity, when compared to Embodiments 1-1 and 3-1 in which vacuum-drying was performed at a lower temperature.

Accordingly, it may be determined that the moisture content of the all-solid-state battery may be reduced, exhibiting the higher initial capacity and the stability of the all-solid-state battery, when the present disclosure includes the vacuum-drying step.

### Experimental Example 4 Evaluation of Charging/Discharging Profile of all-Solid-State Battery Depending on the Sequence of the Vacuum-Drying Step

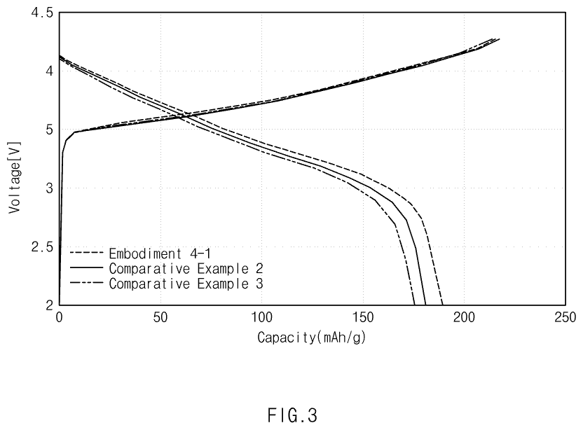

Charging/discharging rate was maintained to 0.2 C using the all-solid-state battery manufactured according to Embodiment 4-1, and Comparative examples 2 and 3, and charging/discharging operations were repeated in the voltage ranging from 2.0 V to 4.25 V, to observe the charging/discharging profile. Thereafter, the charging/discharging capacity, coulomb efficiency, and DC-IR were measured and shown in the following Table 4, and the voltage change according to the capacity was illustrated in a form of a graph as in illustrated in FIG. 3.

TABLE 4

| | Charging | Discharging | | |
|---|---|---|---|---|
| | capacity | capacity | Coulombic | |
| | [mAh/g] | [mAh/g] | efficiency (%) | DC-IR[Ω] |
| Embodiment | 216.42 | 184.92 | 85.4 | 14.21 |
| 4-1 | | | | |
| Comparative | 216.95 | 180.32 | 83.1 | 16.36 |
| example 2 | | | | |
| Comparative | 214.77 | 175.32 | 81.6 | 17.35 |
| example 3 | | | | |

It may be recognized through Table 4 and 3 that the discharging capacity according to an embodiment of the present disclosure subjected to the vacuum-drying step in the manufacturing process exhibited a higher discharging capacity, excellent Coulombic efficiency, and an excellent internal resistance, when compared to the comparative example. It may be recognized that the moisture adsorbed to the electrode remained on the interface without being removed, according to Comparative example 3, in which the vacuum-drying step was performed after the WIP manner, so lower discharging capacity was exhibited. Accordingly, the vacuum-drying step according to an exemplary embodiment of the present disclosure was performed before the WIP manner, maximizing the moisture stability of the all-solid-state battery.

According to an exemplary embodiment of the present disclosure, the method for manufacturing the all-solid-state battery may include the vacuum-drying step to remove the moisture included in the electrode, minimizing the side reaction made by the moisture such that the higher capacity and the stability are exhibited, and the lower resistance characteristic is exhibited.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for manufacturing an all-solid-state battery, the method comprising:
preparing a unit-cell stack including at least one cathode, at least one solid electrolyte layer, and at least one anode;
vacuum-drying the unit-cell stack; and
pressing the vacuum-dried unit-cell stack.

2. The method of claim 1, wherein the vacuum-drying includes:
vacuum-drying the unit-cell stack at a temperature ranging from 50° C. to 200° C.

3. The method of claim 1, wherein the vacuum-drying includes:
vacuum-drying the unit-cell stack for a time ranging from 30 minutes to 48 hours.

4. The method of claim 1, wherein a moisture change rate calculated through following Equation 1 after the vacuum-drying of the unit-cell stack ranges from 15% to 80%.
$$Equation 1$$
$$Moisture change rate ( \% ) = \frac{\begin{matrix}\begin{matrix}Moisture content ( ppm ) \\ in unit cell stack before vaccum drying -\end{matrix} \\ \begin{matrix}Moisture content ( ppm ) \\ in unit cell stack before vaccum drying\end{matrix}\end{matrix} \times 100 \%}{Moisture content ( ppm ) in unit cell stack before vaccum drying}$$

5. The method of claim 1, wherein the pressing includes:
pressing the vacuum-dried unit-cell stack through a Warm Isostatic Pressing (WIP) manner or a roll-press manner.

6. The method of claim 1, further comprising:
forming a cell stack by stacking a plurality of unit-cell stacks pressed;
receiving the cell stack in an exterior material;
secondarily vacuum-drying the cell stack received in the exterior material; and
sealing the exterior material.

7. The method of claim 6, wherein the secondarily vacuum-drying includes:
secondarily vacuum-drying the cell stack received in the exterior material at a temperature ranging from 50° C. to 200° C.

8. The method of claim 6, wherein the secondarily vacuum-drying includes:
secondarily vacuum-drying the cell stack received in the exterior material for a time ranging from 30 minutes to 48 hours.

9. The method of claim 6, wherein the forming of the cell stack includes:
stacking the plurality of unit-cell stacks pressed and performing a tab-welding process for the plurality of unit-cell stacks stacked.

10. The method of claim 1, further comprising:
receiving the unit-cell stack in an exterior material before vacuum-drying the unit-cell stack; and
sealing the exterior material after the vacuum-drying of the unit-cell stack and before the pressing of the unit-cell stack.

11. A system for manufacturing an all-solid-state battery, the system comprising:
a unit-cell stacking device stacking at least one cathode, at least one solid electrolyte layer, and at least one anode to form a unit-cell stack;
a vacuum-drying device vacuum-drying the unit-cell stack; and
a pressing device pressing the vacuum-dried unit-cell stack.

12. The system of claim 11, wherein the vacuum-drying device performs vacuum-drying the unit-cell stack at a temperature ranging from 50° C. to 200° C.

13. The system of claim 11, wherein the vacuum-drying device performs vacuum-drying the unit-cell stack for a time ranging from 30 minutes to 48 hours.

14. The system of claim 11, wherein a moisture change rate calculated through following Equation 1 after the vacuum-drying of the unit-cell stack ranges from 15% to 80%.
$$Equation 1$$
$$Moisture change rate ( \% ) = \frac{\begin{matrix}\begin{matrix}Moisture content ( ppm ) \\ in unit cell stack before vaccum drying -\end{matrix} \\ \begin{matrix}Moisture content ( ppm ) \\ in unit cell stack before vaccum drying\end{matrix}\end{matrix} \times 100 \%}{Moisture content ( ppm ) in unit cell stack before vaccum drying}$$

15. The system of claim 11, wherein the pressing device performs pressing the vacuum-dried unit-cell stack through a Warm Isostatic Pressing (WIP) manner or a roll-press manner.

16. The system of claim 11, further comprising:
a cell stack device forming a cell stack by stacking a plurality of unit-cell stacks pressed by the pressing device;
a stacking packaging device receiving the cell stack in an exterior material;
a secondarily vacuum-drying device secondarily vacuum-drying the cell stack received in the exterior material; and
a stack sealing device sealing the exterior material.

17. The system of claim 16, wherein the secondarily vacuum-drying device performs secondarily vacuum-drying the cell stack received in the exterior material at a temperature ranging from 50° C. to 200° C.

18. The system of claim 16, wherein the secondarily vacuum-drying device performs secondarily vacuum-drying the cell stack received in the exterior material for a time ranging from 30 minutes to 48 hours.

19. The system of claim 11, further comprising:
a cell packaging device receiving the unit-cell stack in a cell exterior material; and
a cell sealing device sealing the cell exterior material,
wherein the cell packaging device is interposed between the unit-cell stacking device and the vacuum-drying device, and
wherein the cell sealing device is disposed to a rear stage of the vacuum-drying device.

20. The system of claim 11, further comprising:
a cell packaging device receiving the unit-cell stack in a cell exterior material before the vacuum-drying device performs vacuum-drying the unit-cell stack; and
a cell sealing device sealing the cell exterior material after the vacuum-drying device performs vacuum-drying the unit-cell stack and before the pressing device performs pressing of the unit-cell stack,
wherein the cell packaging device is interposed between the unit-cell stacking device and the vacuum-drying device, and
wherein the cell sealing device is disposed to a rear stage of the vacuum-drying device.
